(19) United States
(12) Patent Application Publication
(10) Pub. No.: US 2023/0415863 A1
(43) Pub. Date: Dec. 28, 2023

(54) PARTICLE ALGORITHM-BASED METHOD FOR UNDERWATER DETECTION AND OPERATION POSITIONING OF RESERVOIR DAM SYSTEM

(71) Applicant: NANJING HYDRAULIC RESEARCH INSTITUTE, Jiangsu (CN)

(72) Inventors: Yan Xiang, Jiangsu (CN); Zhengyang Su, Jiangsu (CN); Hailiang Yang, Jiangsu (CN); Xin Yang, Jiangsu (CN); Chengdong Liu, Jiangsu (CN); Kai Zhang, Jiangsu (CN); Bo Dai, Jiangsu (CN); Yakun Wang, Jiangsu (CN); Siyu Chen, Jiangsu (CN); Ying Meng, Jiangsu (CN); Liushan Tang, Jiangsu (CN)

(73) Assignee: NANJING HYDRAULIC RESEARCH INSTITUTE, Jiangsu (CN)

(21) Appl. No.: 18/341,755

(22) Filed: Jun. 26, 2023

(30) Foreign Application Priority Data
Jun. 27, 2022 (CN) 202210738414.9

(51) Int. Cl. B63B 71/10; B63G 8/00

(52) U.S. Cl. CPC B63B 71/10; B63G 8/001; B63G 2008/007

(57) ABSTRACT

Disclosed is a particle algorithm-based method for underwater detection and operation positioning of a reservoir dam system. A water body is stimulated by adopting a smoothed particle hydrodynamics (SPH) method, the ROV is simulated by adopting a discrete element method (DEM) unit formed by a series of particles, an umbilical cable between the ROV and a water surface control unit are simulated by a spring unit, dynamic interaction among the ROV, water flow and the cable are calculated by combining the SPH method and the DEM, and real-time motion positions of the ROV and the cable in complex environments are calculated and obtained; and a relative position between the ROV and the surface control unit can be calculated through the real-time position of the cable, and the real-time underwater positioning of the ROV is realized in combination with an absolute coordinate position of the surface control unit.

### CROSS-REFERENCE TO RELATED APPLICATION

This application claims the priority benefit of China application serial no. 202210738414.9, filed on Jun. 27, 2022. The entirety of the above-mentioned patent application is hereby incorporated by reference herein and made a part of this specification.

### TECHNICAL FIELD

The present invention relates to an underwater positioning method, in particular to a particle algorithm-based method for underwater detection and operation positioning of a reservoir dam system.

### BACKGROUND ART

In recent years, remote operated vehicles (ROVs, also known as “unmanned underwater vehicles”) have been increasingly used for underwater detection of underwater structures, such as reservoir dams and culverts (tunnels), as shown in FIG. 1. Accurate underwater positioning is a prerequisite for an ROV to accomplish various complex tasks underwater. Currently, it is still difficult for the ROV to perform underwater positioning in complex environments such as reservoirs and long-distance culverts (tunnels). In a reservoir environment, ROV performs the underwater positioning chiefly based on an ultra-short baseline and a GPS. As shown in FIG. 2, the ROV suffers poor transmission of underwater positioning signal. The ultra-short baseline is mainly applied to a marine environment. A built-in GPS of the traditional ultra-short baseline is insufficient in terms of positioning accuracy, and can only provide global WGS84 coordinates, upon which it is impossible to obtain local absolute coordinates of a dam environment. The content of suspended substances in a culvert (tunnel) is higher than that in a water body in a reservoir, underwater positioning acoustic signals of the ROV are subjected to a relatively serious reflection interference, and the visibility of the water body is relatively low, making the deployment of positioning auxiliary facilities highly difficult, therefore, it is very difficult to accurately position the ROV. Besides, when underwater detection is performed by the ROV in complex environments such as reservoirs and culverts (tunnels), water seepage points, cracks and other minor defects on dam surfaces or tunnel walls need to be detected and defect positions need to be identified. Most of the cracks are of millimeter level, making accurate positioning of the ROV underwater more difficult and posing a higher requirements for positioning accuracy of the ROV. Further, the ROV usually adopts acoustic means to perform underwater positioning. In the reservoir environment, the ROV underwater detection is mainly performed in such areas as dams, entrances of outlet structures and conveyance structures, near-dam reservoir banks and bottoms of the reservoir. These areas have complex environments and geometric shapes, and different media below the water surface have different reflection characteristics of acoustic waves, resulting in multipath reflection of the acoustic waves emitted by an acoustic positioning system in the reservoir environment on near-dam reservoir banks and mountains, as well as the bottoms of the reservoir. Furthermore, hydraulic structures in different geometric shapes will also form various absorption, reflection and diffraction effects on the acoustic waves. In addition, the turbidity of the reservoir water body on rivers with a large amount of sediment during the flood season is higher, and the visibility of the operating water is low, which will also cause attenuation effect on the acoustic signal. These underwater positioning instruments and equipment need to be further improved in positioning accuracy, and are subjected to some applicable conditions, so that these instruments and equipment should be deployed and measured in combination with field conditions.

### SUMMARY

An objective of the present invention: aiming at the above problems, the present invention provides a particle algorithm-based method for underwater detection and operation positioning of a reservoir dam system, which can effectively improve the underwater positioning accuracy of a remote operated vehicle (ROV).

A technical solution: a technical solution adopted by the present invention is a particle algorithm-based method for underwater detection and operation positioning of a reservoir dam system. A water body is stimulated by adopting a smoothed particle hydrodynamics (SPH) method, the ROV is simulated by adopting a discrete element method (DEM) unit formed by a series of particles, an umbilical cable between the ROV and a water surface control unit are simulated by a spring unit, dynamic interaction among the ROV, water flow and the cable are calculated by combining the SPH method and the DEM, and real-time motion positions of the ROV and the cable in complex environments are calculated and obtained; and a relative position between the ROV and the surface control unit can be calculated through the real-time position of the cable, and the real-time underwater positioning of the ROV is realized in combination with an absolute coordinate position of the surface control unit.

Specifically, the method includes: establishing an ROV particle model, analyzing flow characteristics in complex environments, simulating a dynamic motion process of the ROV, and calculating the ROV underwater position in real time.

When establishing an ROV particle model, the ROV is dispersed into the DEM unit formed by a series of particles by adopting the DEM.

When analyzing flow characteristics in complex environments, the flow characteristics, including flow velocity and flow direction, of the water flow in the complex environments are captured by a current meter.

When simulating a dynamic motion process of the ROV, the motion process of the ROV in the complex environments are calculated and obtained based on the measured flow velocity and flow direction of the water flow in the complex environments, and the calculation process includes:

(1) stimulating the interaction between water bodies by adopting the SPH method, and solving based on the following continuity equation and momentum equation:

$$\frac{{dv}_{i}^{α}}{dt} = {\sum }_{j = 1}^{N} {m}_{j} ( \frac{{σ}_{i}^{αβ}}{{ρ}_{i}^{2}} + \frac{{σ}_{h}^{αβ}}{{ρ}_{j}^{2}} + {T}_{ij} ) \frac{\partial {W}_{ij , β}}{\partial {x}_{i}^{β}} \\ \frac{d {ρ}_{i}}{dt} = {\sum }_{j = 1}^{N} {m}_{j} {v}_{ij}^{β} \frac{\partial {W}_{ij , β}}{\partial {x}_{i}^{β}}$$

in the equations above, ρ is the density of a base point, t is a calculation time, m is a mass of the base point, v is a velocity of the mass point, x is a position coordinate of the base point, σ^{α,β} is a stress tensor of the base point, T is an artificial viscosity item, W is a smoothing kernel function of the SPH, α and β respectively represent stress tensor marks, i and j respectively represent the i^{th} and the j^{th} particles in the water body, and N represents the number of particles; and

(2) solving the interaction between the water body and the ROV by adopting the by adopting the coupling of the SPH method and the DEM; and the total resultant force on the ROV is calculated by analyzing the contact acting force relationship between particles of the water body and DEM unit particles of the ROV, the resultant force is calculated as external force on the DEM unit, and the motion process of the ROV is simulated and calculated.

When calculating the ROV underwater position in real time, the ROV underwater position is calculated based on an initial position of the control unit (X₀, Y₀, Z₀), a real-time position of the cable at time t and a dynamic position of the ROV (Xₜ, Yₜ, Zₜ) calculated through simulation numerical values during the dynamic motion process of the ROV, and an absolute position coordinate of the ROV can be obtained by calculating relative position coordinates of the control unit and the ROV.

### BRIEF DESCRIPTION OF THE DRAWINGS

FIG. 1 is a schematic diagram of an ROV performing underwater detection in a culvert;

FIG. 2 is a schematic diagram of underwater positioning signal transmission of an ROV;

FIG. 3 is a schematic diagram of system composition of an ROV;

FIG. 4 is a particle model diagram of an ROV;

FIG. 5 is a schematic diagram of contact acting force relationship between particles of a water body and an ROV;

FIG. 6 is a diagram of an initial position of an ROV;

FIG. 7 is a position calculation diagram of an ROV under different flow regimes;

FIG. 8 is a comparison chart of the calculation results of ROV motion posture and position under two different flow regimes; and

FIG. 9 is a relative positional relationship among a control unit, a cable and an ROV.

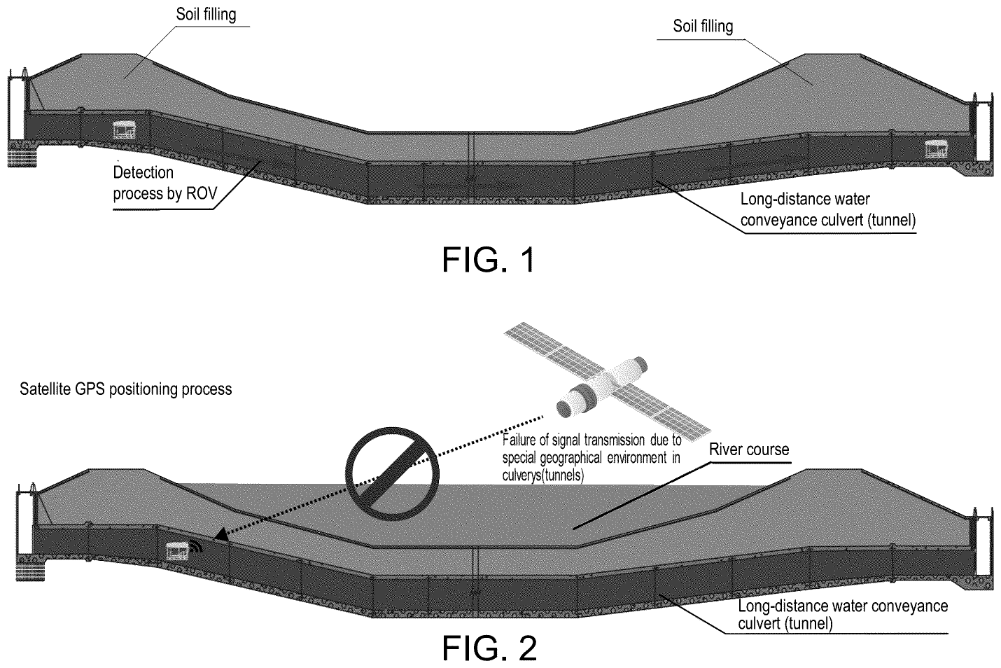

### DETAILED DESCRIPTION OF THE EMBODIMENTS

The technical solution of the present invention will be further described below with reference to the accompanying drawings and the embodiments.

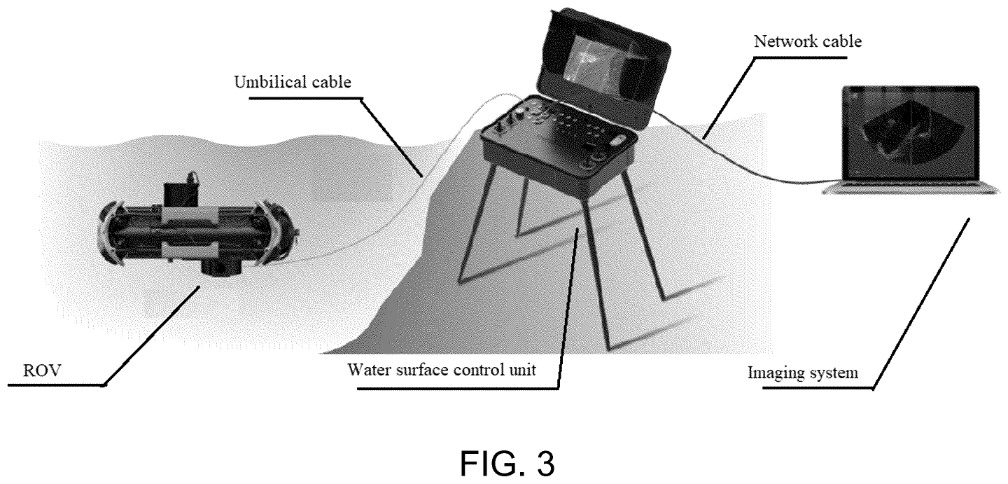

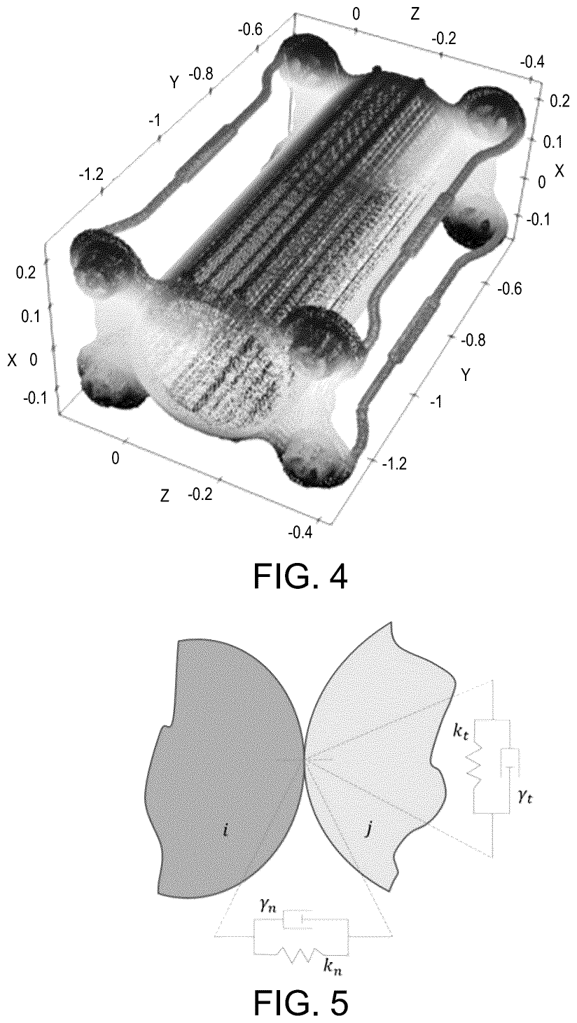

According to a particle algorithm-based method for underwater detection and operation positioning of a reservoir dam system of the present invention, dynamic interaction among an ROV, water flow and a cable is calculated by adopting the coupling of a smoothed particle hydrodynamics (SPH) method and a discrete element method (DEM). A water body is simulated by adopting the SPH method, the ROV is simulated by adopting a DEM unit formed by a series of particles, and an umbilical cable between the ROV and a water surface control unit are simulated by a spring unit, so that a real-time motion position of the ROV in complex environments such as a reservoir or culvert (tunnel) is obtained. A relative position between the ROV and the surface control unit is obtained by calculating a real-time of the ROV and the cable, and the real-time underwater positioning of the ROV is realized in combination with an absolute coordinate position of the surface control unit. Specifically, it includes the following parts: establishing an ROV particle model, analyzing flow characteristics in a reservoir or a culvert (tunnel), simulating a dynamic motion process of the ROV, and calculating the ROV underwater position in real time. ROV stands for remote operated vehicle, also known as underwater robot, with the system composition shown in FIG. 3.

(1) Establishing an ROV Particle Model.

The ROV particle model is established by adopting the DEM. A three-dimensional particle model is established by adopting the DEM.

(2) Identifying Flow Characteristics in a Reservoir or a Culvert (Tunnel).

The flow characteristics, including flow velocity and flow direction, of water flow in the reservoir or the culvert (tunnel), can be captured by a current meter.

(3) Simulating a Dynamic Motion Process of the ROV.

Based on the measured flow velocity and flow direction of the water flow in the reservoir or the culvert (tunnel), the ROV motion process in the complex environments, such as the reservoir or culvert (tunnel), is calculated, and the ROV motion posture and cable position are calculated in real time.

The solving process includes:

a. the interaction between water bodies is simulated by the SPH method and is solved based on the following continuity equation and momentum equation:

$$\frac{{dv}_{i}^{α}}{dt} = {\sum }_{j = 1}^{N} {m}_{j} ( \frac{{σ}_{i}^{αβ}}{{ρ}_{i}^{2}} + \frac{{σ}_{h}^{αβ}}{{ρ}_{j}^{2}} + {T}_{ij} ) \frac{\partial {W}_{ij , β}}{\partial {x}_{i}^{β}} \\ \frac{d {ρ}_{i}}{dt} = {\sum }_{j = 1}^{N} {m}_{j} {v}_{ij}^{β} \frac{\partial {W}_{ij , β}}{\partial {x}_{i}^{β}}$$

in the equations above, ρ is a density of a base point, in kg/m³; t is a calculation time, in s; m is a mass of the base point, in kg; v is a velocity of the mass point, in m/s; x is a position coordinate of the base point, in m; and σ^{α,β} is a stress tensor of the base point, in Pa; T is an artificial viscosity item to reduce the non-physical vibration in the calculation process; W is a smoothing kernel function of the SPH, α and β respectively represent stress tensor marks, i and j respectively represent the i^{th} and the j^{th} particles in the water body, and N represents the number of particles.

b. The interaction between the water body and the ROV is solved by combining the SPH method and the DEM, and the interaction relationship between particles is shown in FIG. 5. The total resultant force on the ROV is calculated by analyzing the contact acting force relationship between particles of the water body and DEM unit particles of the ROV, and the motion process of the ROV is simulated and calculated.

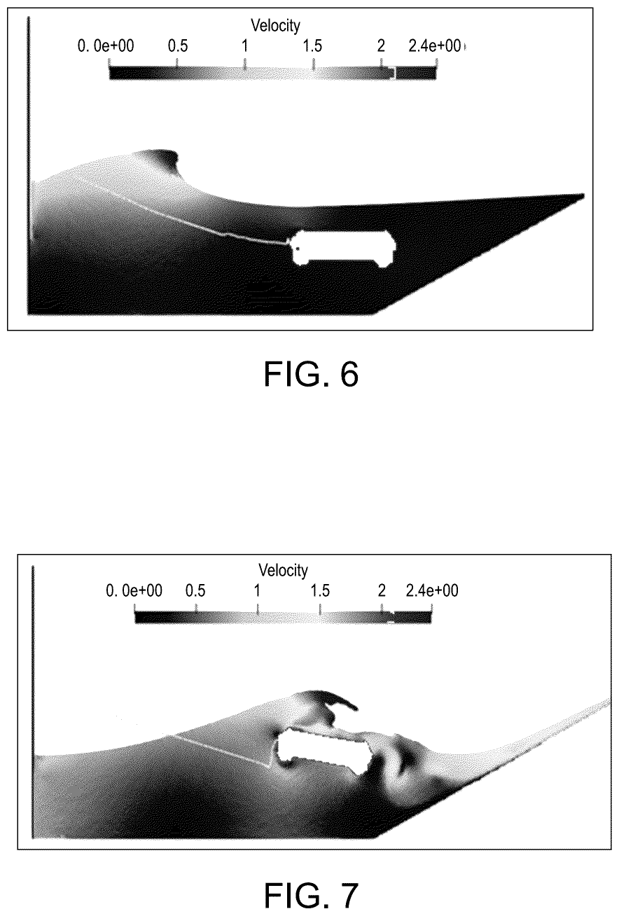

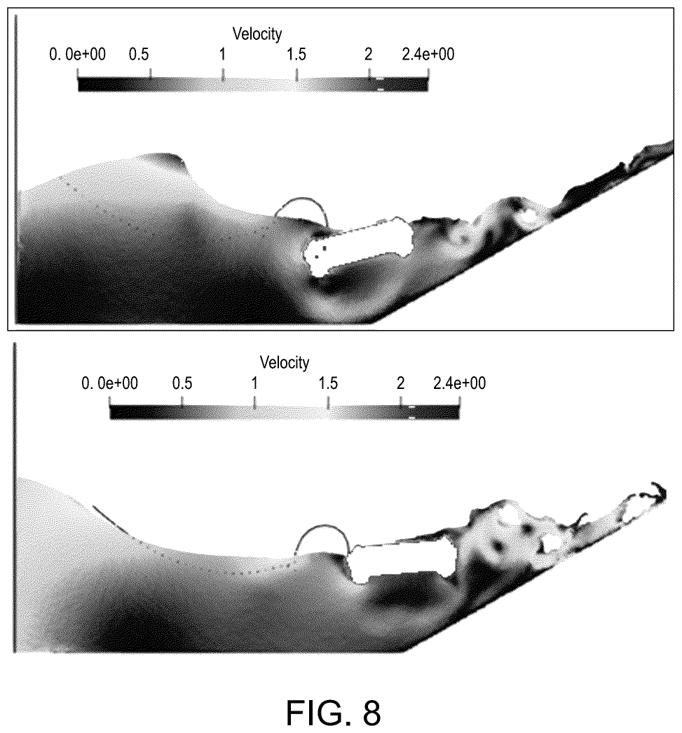

The initial position of the ROV is known, as shown in FIG. 6, and calculation results obtained by adopting the above algorithm to solve the position of a machine cable of the ROV in different flow regimes are shown in FIG. 7. FIG. 8 shows a comparison chart of the calculation results of ROV motion posture and position under two different flow regimes.

(4) Calculating the ROV Underwater Position in Real Time.

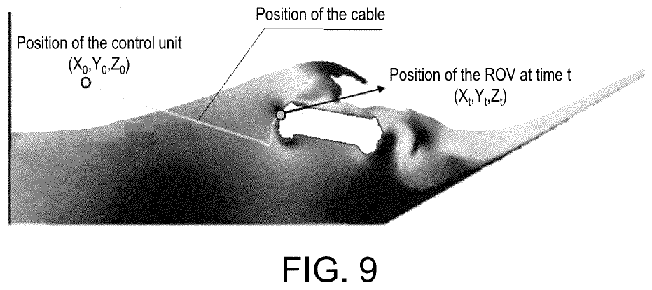

Based on an initial position of the control unit (X₀, Y₀, Z₀), a real-time position of the cable at time t and a dynamic position of the ROV (Xₜ, Yₜ, Zₜ) calculated through simulation numerical values during the dynamic motion process of the ROV, and an absolute position coordinate of the ROV can be obtained by calculating relative position coordinates of the control unit and the ROV. FIG. 9 shows that, in the reservoir or culvert (tunnel) environment, the relative position between the ROV and the surface control unit can be calculated through the real-time position of the cable, and the real-time underwater positioning of the ROV can be realized in combination with the absolute coordinate position of the water surface control unit.

Beneficial effects: compared with the prior art, the present invention has the following advantages: (1) the present invention can obtain the motion position information of the ROV at each moment through calculation based on dynamic numerical values, and realize the real-time underwater positioning by the ROV, featuring low positioning cost and easy to implement; (2) the present invention performs the positioning through particle algorithm, so that accurate relative positioning coordinates of the ROV can be identified quickly, accurate underwater positioning of the ROV is achieved, thereby breaking through limitations on deploying traditional positioning apparatuses in complex environments, and effectively avoiding signal interference and other problems faced by acoustic positioning means; (3) the present invention can quickly and simply obtain accurate relative positioning coordinates in complex environments such as deep-water environments of dams or long-distance culverts (tunnels); and (4) in view of some complex flow environments such as floodgate discharge and tunnel discharge, when positioning apparatus are deployed for underwater positioning by the ROV, the safety of underwater operation by the ROV cannot be guaranteed. This method can predict the motion posture and position of the ROV, thereby reducing the risk of ROV operation in such complex flow environments.

This algorithm can be applied to different types of underwater positioning problems of ROVs, and is also suitable for solving underwater positioning problems of the ROVs in different application scenarios, such as culverts, tunnels, pressure steel pipes, dams, reservoirs in front of dams, and the like.

What is claimed is:

1. A particle algorithm-based method for underwater detection and operation positioning of a reservoir dam system, wherein a water body is stimulated by adopting a smoothed particle hydrodynamics (SPH) method, a remote operated vehicle (ROV) is simulated by adopting a discrete element method (DEM) unit formed by a series of particles, an umbilical cable between the ROV and a water surface control unit are simulated by a spring unit, dynamic interaction among the ROV, water flow and the cable are calculated by combining the SPH method with the DEM, and real-time motion positions of the ROV and the cable in complex environments are calculated and obtained; and a relative position between the ROV and the surface control unit can be calculated through the real-time position of the cable, and the real-time underwater positioning of the ROV is realized in combination with an absolute coordinate position of the surface control unit.

2. The particle algorithm-based method for underwater detection and operation positioning of a reservoir dam system according to claim 1, wherein the method comprises: establishing an ROV particle model, analyzing flow characteristics in complex environments, simulating a dynamic motion process of the ROV, and calculating the ROV underwater position in real time.

3. The particle algorithm-based method for underwater detection and operation positioning of a reservoir dam system according to claim 2, wherein when establishing an ROV particle model, the ROV is dispersed into a DEM unit formed by a series of particles by adopting the DEM method.

4. The particle algorithm-based method for underwater detection and operation positioning of a reservoir dam system according to claim 2, wherein when analyzing flow characteristics in complex environments, the flow characteristics, comprising flow velocity and flow direction, of the water flow in the complex environments are captured by a current meter.

5. The particle algorithm-based method for underwater detection and operation positioning of a reservoir dam system according to claim 2, wherein when simulating a dynamic motion process of the ROV, the motion process of the ROV in the complex environments are calculated based on the measured flow velocity and flow direction of the water flow in the complex environments, and the calculation process comprises:
(1) stimulating the interaction between water bodies by adopting the SPH method, and solving based on the following continuity equation and momentum equation:
$$\frac{{dv}_{i}^{α}}{dt} = {\sum }_{j = 1}^{N} {m}_{j} ( \frac{{σ}_{i}^{αβ}}{{ρ}_{i}^{2}} + \frac{{σ}_{h}^{αβ}}{{ρ}_{j}^{2}} + {T}_{ij} ) \frac{\partial {W}_{ij , β}}{\partial {x}_{i}^{β}} \\ \frac{d {ρ}_{i}}{dt} = {\sum }_{j = 1}^{N} {m}_{j} {v}_{ij}^{β} \frac{\partial {W}_{ij , β}}{\partial {x}_{i}^{β}}$$
in the equations above, p is the density of a base point, t is a calculation time, m is a mass of the base point, v is a velocity of the mass point, x is a position coordinate of the base point, σ^{α,β} is a stress tensor of the base point, T is an artificial viscosity item, W is a smoothing kernel function of the SPH, α and ƒt respectively represent stress tensor marks, i and j respectively represent the i^{th} and the j^{th} particles in the water body, and N represents the number of particles; and
(2) solving the interaction between the water body and the ROV by combining the SPH method and the DEM method; and the total resultant force on the ROV is calculated by analyzing the contact acting force relationship between particles of the water body and DEM unit particles of the ROV, the resultant force is calculated as external force on the DEM unit, and motion processes of the ROV and the cable is simulated and calculated.

6. The particle algorithm-based method for underwater detection and operation positioning of a reservoir dam system according to claim 2, wherein when calculating the ROV underwater position in real time, the ROV underwater position is calculated based on an initial position of the control unit (X₀, Y₀, Z₀), a real-time position of the cable at time t and a dynamic position of the ROV (Xₜ, Yₜ, Zₜ) calculated through simulation numerical values during the dynamic motion process of the ROV, and an absolute position coordinate of the ROV can be obtained by calculating relative position coordinates of the control unit and the ROV.
